(19) United States
(12) Patent Application Publication
(10) Pub. No.: US 2004/0252814 A1
(43) Pub. Date: Dec. 16, 2004

(54) System and method of voice message recording and delivery

(76) Inventor: William J. Eakin, Mt. Laurel, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/461,246

(22) Filed: Jun. 13, 2003

(51) Int. Cl. H04M 1/64

(52) U.S. Cl. 379/88.17; 379/88.12

(57) ABSTRACT

A voice messaging system comprises a server, a voice message storage device coupled to the server, and a voice interface executing on the server operable to receive and store a voice message from the caller in the voice message storage device. A web interface executing on the server is operable to deliver a notification over a network to at least one communication device associated with at least one receiver of the voice message. The web server is further operable to deliver the recorded voice message over the global network to the at least one communication device associated with the at least one receiver.

### TECHNICAL FIELD OF THE INVENTION

The present invention relates generally to the field of computing devices and methods, and in particular, to a system and method of voice message recording and delivery.

### BACKGROUND OF THE INVENTION

Although methods have been devised to facilitate communications, such as electronic mail, some still believe in the tone and nuances that can be communicated with a personal voice conveyed over a telephone line. Voicemail or the telephone answering machine has long been widely used for business and personal matters. However, the conventional voicemail systems commonly used in businesses and answering machines commonly used in residences both have the limitations on available recording storage space. Most systems and machines impose a restrictive time limit on the length of the voicemail that may be recorded. Therefore, many users of conventional voicemail have experienced being cut off in the middle of recording a message, and go through the inconvenience of having to redial the telephone number again to continue the voice message. Furthermore, personal answering machines are at times unreliable depending on the recording medium. Analog recordings made on small audio cassette tapes often become garbled and unintelligible due to the age and repeated wearing of the tape. Most residential users also do not have access to the features of voice mail systems that are used by businesses, such as sending a broadcast voice message to members of a distribution list. These and other limitations make the conventional voicemail and voice recordings less than ideal solutions for today's communication needs.

### SUMMARY OF THE INVENTION

In accordance with an embodiment of the present invention, a voice messaging system comprises a server, a voice message storage device coupled to the server, and a voice interface executing on the server operable to receive and store a voice message from the caller in the voice message storage device. A web interface executing on the server is operable to deliver a notification over a network to at least one communication device associated with at least one receiver of the voice message. The web server is further operable to deliver the recorded voice message over the network to the at least one communication device associated with the at least one receiver.

In accordance with another embodiment of the invention, a voice communication method comprises receiving a call from a message sender at a predetermined telephone number, receiving an audio message from the message sender, storing the audio message in a message storage device communicatively coupled to a network, and receiving at least one identifier of at least one message receiver. The method further comprises sending a notification to at least one communication device of the at least one message receiver.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of an exemplary operating environment of an embodiment of the present invention;

FIG. 2 is a flowchart of an embodiment of a voice message recording and delivery system and method of the present invention;

FIG. 3 is a flowchart of an embodiment of a voice message recording and delivery user configuration process of the present invention; and

FIG. 4 is a simplified block diagram of a server communicating with a communication device of a message receiver.

### DETAILED DESCRIPTION OF THE DRAWINGS

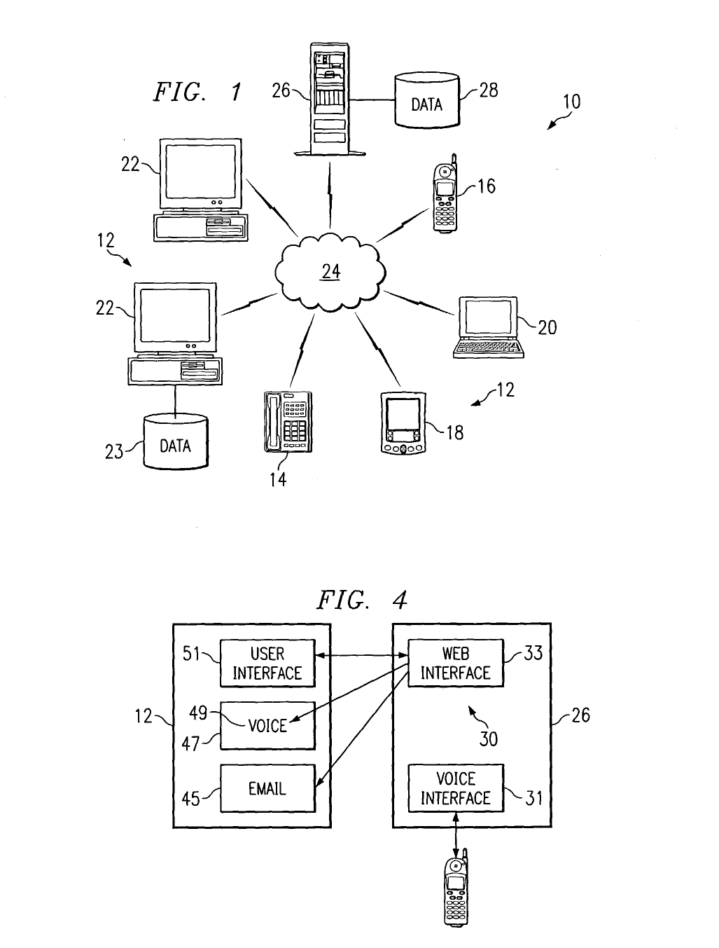

The preferred embodiment of the present invention and its advantages are best understood by referring to FIGS. 1 through 4 of the drawings, like numerals being used for like and corresponding parts of the various drawings.

FIG. 1 is a simplified block diagram of an exemplary computing environment of an embodiment of the system and method of voice recording and delivery 10 of the present invention. Users use communication devices 12 ranging from telephones 14, mobile phones 16, personal digital assistants 18, to laptops 20, personal computers (PCs), tablet PCs and workstations 22 to perform a variety of tasks. These devices 12 are operable to communicate with other such devices via one or more networks 24 that range from local to the global scale, such as local area network (LAN), wide area network (WAN), telecommunication network, intranet, and the Internet. Some of these devices may be coupled to one or more data storage devices such as a database 23. These devices 12 are further equipped with one or more speakers (not explicitly shown). A voice message server 26 is coupled to communication devices 12 via network 24. One or more data storage devices 28 are coupled to voice message server 26. The software code associated with one or more embodiments of voice recording and delivery system and method may execute at any and/or all of communication devices 12 and voice message server 26.

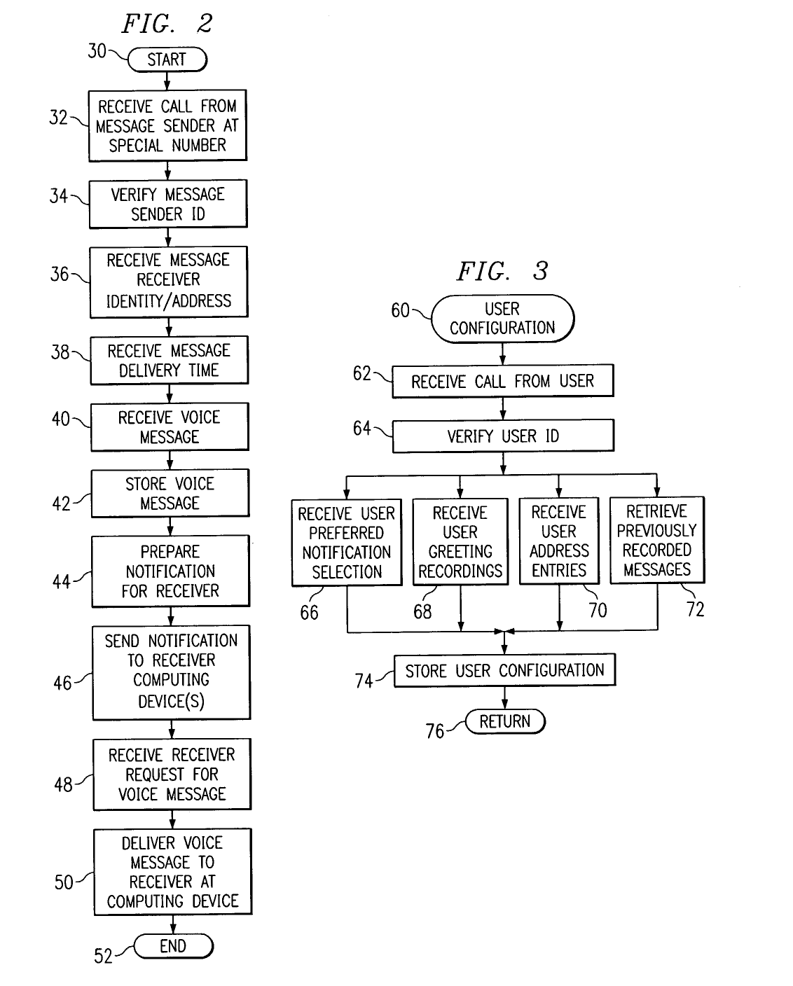

FIG. 2 is a flowchart of an embodiment of a user interface 30 of the voice message recording and delivery system and method of the present invention. User interface 30 includes a voice interface 31 and a web interface 33 (FIG. 4). Voice interface 31 is operable to communicate with a user primarily via a telephone or mobile phone, for example, and web interface 33 is operable to communicate with a user primarily via an electronic mail application and/or a web-enabled application, for example. Users having this voice message service, such as subscribers, may be given one or more specifically designated telephone numbers to call to access the service. When a user calls the designated telephone number, server 26 or computer software applications operating thereon provides a voice interface to answer the call, as shown in block 32. The designated telephone number may be one that is assigned to a particular subscriber, or one that is used to access the service.

The user is then optionally prompted by voice interface 31 to enter one or more sets of personal codes, such as a specific combination of alphanumeric digits that was previously configured as that particular user's identifier and/or password, which may be referenced as an authenticator hereinafter. The authenticator may alternatively be the telephone number or device identifier of the device originating the call. The touch-tone telephone or mobile phone generates dual-tone multi-frequency (DTMF) signals when the keys are pressed, which are recognized and matched to stored identifiers and passwords. When voice recognition is supported, the user may be prompted to speak a password. The spoken sounds are then matched to stored sound files of identifiers and passwords. System 10 verifies the entered identifier, as shown in block 34. Alternatively, sophisticated voice signature analysis methods may be used to authenticate and verify the identity of the caller. In an alternate embodiment, each user may be assigned a unique telephone number that uniquely identifies the user. If the subscriber calls a telephone number that is designated to him/her specifically, then the web interface may simply recognize the caller by the telephone number called, and the originating telephone number or device identifier of the telephone used to make the call.

The user is then prompted to enter the voice message receiver's identifier, which may be in the form of a name, a telephone number, an electronic mail address, etc. entered by using the telephone keypad, which in turn generates DTMF signals. The term “receiver” herein may refer to a person, or to a communication device. The user may store an address book or list with the necessary contact information of message receivers and configure personal distribution lists consisting of members from his/her address book. Each name in the address book may include one or more contact information, such as one or more electronic mail address and/or telephone number.

The voice interface receives one or more voice message receivers' identifiers or specification of a distribution list, as shown in block 36. If equipped with voice recognition, the user may provide the receiver information by uttering a name, telephone number, or electronic mail address, distribution list name, etc. If the user desires to simply leave a voice message for him/herself, such as a task reminder or a shopping list, one or two key sequences may be preset for the user to specify this function without having to press many keys. The user is then prompted to enter or specify a message delivery time, which may include a specification of a date. The user may have configured a default message delivery time, such as immediately, and may select the preset default or specify a different delivery time. For example, the user may desire the voice message to be delivered to a set of receivers at 10 A.M. the following morning. As another example, the user may also pre-record certain greetings and wishes for different members of his/her family set to be delivered on the birthdays, anniversaries, and other special occasions. A sales manager may use this service to pre-record a sales promotional message for delivery within a certain time window to sales targets to conform with local and state laws. The voice interface receives the specified message delivery time, as shown in block 38. It should be noted that the voice message receiver identification and/or delivery time entry functionalities are optional in a preferred embodiment.

The user is then prompted by voice interface 31 for the voice message, which is then received and stored by server 26 of system 10 in database 28 (FIG. 1), as shown in blocks 40 and 42. Web interface 33 of system 10 then prepares and sends a notification to the receiver, as shown in blocks 44 and 46. The delivering of a notification may be optional or disabled depending on the embodiment. Depending on what the user had previously configured his/her account and/or for the particular receiver, the notification may be sent as an electronic mail 45, as a text message, as a phone call, or as an icon 49 on the receiver's computing device screen, desktop or toolbar 47 (FIG. 4). A client user interface application 51 may execute on one or more chosen computing platform of the message receiver which periodically pull or poll for status or notification from web interface 33. Upon receiving an indication from the web server that a voice message is pending, user interface 51 displays an icon 49 on the user's desktop or screen 47. Other methods of notification now known or later developed may also be used, such as instant messaging. The icon may be displayed in a manner as to attract attention from the user, such as blinking and alternating contrasting colors, for example. The voice message delivery method may depend on the selected notification method. The notification is sent timed according to the user-specified delivery date and time if that option is selected. In an alternate embodiment, the subscriber to the voice messaging service simply leaves the voice message recording, which is stored in database 28. A link to the stored voice message recording is then provided on a predetermined web page, such as a web page accessible to the subscriber and/or some authorized persons.

In blocks 48 and 50, a receiver's request for the voice message is received and the voice message is delivered to the receiver. The notification preferably enables the receiver to easily request and access the voice message. For example, the electronic mail notification 45 may contain a link (such as a hypertext link) to an audio file, such as a WAV, WINDOWS MEDIA, REAL MEDIA, or MP3 file, that may be clicked by the user to download the file for later playback on the speakers (not shown) coupled to computer 22 or to stream the audio file for immediate playback. Desktop or screen icon 49, when clicked, may open a user interface (such as a dialog window) that contain a link to the voice message audio file. A telephone call notification, when answered by the receiver, may begin playing the voice message, either immediately, after a predetermined pause, or upon request by the receiver. These notifications may be sent to any or all of the communication devices of the particular receiver, as specified by the sender. Because server 26 is web-enabled, the receivers may access the voice message from virtually anywhere. The process ends in block 52.

FIG. 3 is a flowchart of an embodiment of a voice message recording and delivery user configuration process 60 according to the present invention. The voice interface receives a call from the user at the predetermined telephone number designated to the particular user, as shown in block 62. The user's identification is then received and verified, as shown in block 64. If the user accesses the service using a telephone number designated to him/her, then the authentication step may be streamlined as described above. The user may then perform a number of functions, examples of which are shown in FIG. 3. For example, the user may specify the preferred notification method for his/her voice messages, as shown in block 66. The user may record one or more voice messages for greeting receivers who request voice messages, as shown in block 68. The user may enter one or more names and contact information in his/her address book, as shown in block 70. In addition, the user may also indicate the preferred notification and message delivery method for each address book entry. The user may also retrieve previously recorded voice messages, whether destined for him/herself or another receiver, a shown in block 72. The user may reuse previously recorded and delivered voice messages for later deliveries to different receivers or for repeated deliveries to the same receivers at specified times. Server 26 stores the user's configurations, as shown in block 74. The process ends in block 76.

In addition to the applications described above, embodiments of the voice message recording and delivery system and method of the present invention are especially suited to applications where the user desires to send the same voice message to a number of different receivers at a specified time, and/or to more than one different type of communication devices. Because the intended caller interface device is the telephone or the mobile telephone, the user may perform all of the user functions using this ubiquitous device. Further, instead of having to carry a voice recorder or a dictation machine, a user may push a speed dial number on his/her mobile phone, which connects him/her to server 26, and enables him/her to dictate a voice message to him/herself or as relating to a particular matter. This voice recording is then available to anyone who has web access. For example, the user may dictate a letter, which is stored in the server database. His/her assistant may then access it to transcribe and send it. The user does not have to time his/her call to coincide with the availability of the assistant, or to limit the length of the dictation. The same may also be used by users to leave lengthy instructions and directions to the receivers of the voice message without being cut off.

It may be seen that it is preferable to streamline the user access and authentication process as much as possible. For example, the authentication process may be simplified by enabling the user to access the service using a telephone number specifically designated the user, and/or by detecting and matching the calling number to one in the record as belonging to the user. It is possible to provide voice signature analysis and other technologies to authenticate users. The voice interface using a telephone is more preferable and less time consuming for many users who have difficulty mastering the required handwriting strokes to compose and send electronic mail on a personal digital assistant while on the go. In the simplest form, the user may simply press a speed dial number or a predetermined key on the telephone that connects the user to the voice messaging service. Upon connection, the user issues a voice command to indicate a desire to record a voice message and then speaks the voice message. The message is recorded and stored in a database accessible via the World Wide Web or Internet, and a link thereto is provided on a predetermined web page. The web page may have security and other measures to ensure only those with authorization may access the voice message recording.

In an alternate embodiment, the above-described service may be receiver-driven. For example, a receiver who is a subscriber of the service may receive a phone call and is unable to answer the call. The caller is able to leave a voice message for the receiver and have a notification delivered to the receiver at a specified time and date as described above.

What is claimed is:

1. A voice messaging system, comprising:
a server;
a voice message storage device coupled to the server;
a voice interface executing on the server operable to receive and store a voice message from the caller in the voice message storage device; and
a web interface executing on the server operable to deliver a notification over a network to at least one communication device associated with at least one receiver of the voice message, and deliver the recorded voice message over the global network to the at least one communication device associated with the at least one receiver.

2. The voice messaging system, as set forth in claim 1, wherein the web interface executing on the server is operable to deliver a notification over a global network.

3. The voice messaging system, as set forth in claim 1, wherein the web interface is operable to deliver a notification over the network to a communication device pursuant to a predetermined delivery time.

4. The voice messaging system, as set forth in claim 1, wherein the web interface is operable to deliver a notification over the network to a communication device in response to a request by the at least one receiver.

5. The voice messaging system, as set forth in claim 1, wherein the web interface is operable to deliver the notification over the network to the at least one communication device pursuant to predetermined timing specified by the caller.

6. The voice messaging system, as set forth in claim 1, wherein the web interface is operable to deliver the notification over the network to at least one communication device selected from the group consisting of personal digital assistant, personal computer, tablet PC, workstation, laptop computer, notebook computer, telephone, and mobile phone.

7. The voice messaging system, as set forth in claim 1, wherein the web interface is operable to deliver the voice message over the network to at least one communication device selected from the group consisting of personal digital assistant, personal computer, tablet PC, workstation, laptop computer, notebook computer, telephone, and mobile phone.

8. The voice messaging system, as set forth in claim 1, wherein the voice interface is further operable to receive an identifier of the caller and verifying the identifier.

9. The voice messaging system, as set forth in claim 1, wherein the voice interface is further operable to receive a spoken identifier of the caller and verifying the spoken identifier.

10. The voice messaging system, as set forth in claim 1, wherein the voice interface is further operable to receive a DTMF identifier of the caller and verifying the DTMF identifier.

11. The voice messaging system, as set forth in claim 1, wherein the web interface is operable to display a notification icon on a screen of the at least one communication device.

12. The voice messaging system, as set forth in claim 1, wherein the web interface is operable to display a notification icon on a desktop screen of the at least one communication device.

13. The voice messaging system, as set forth in claim 1, wherein the web interface is operable to display a notification icon on a screen of the at least one communication device, the notification icon operable to provide a link to an audio file stored in the voice message storage device.

14. The voice messaging system, as set forth in claim 1, wherein the web interface is operable to deliver an electronic mail notification to the at least one communication device.

15. The voice messaging system, as set forth in claim 1, wherein the web interface is operable to deliver an electronic mail notification to the at least one communication device, the notification electronic mail operable to provide a link to an audio file stored in the voice message storage device.

16. The voice messaging system, as set forth in claim 1, further comprising an address book stored in the voice message storage device, the address book having at least one entry and at least one communication contact information related to at least one communication device for each entry.

17. The voice messaging system, as set forth in claim 1, further comprising an address book stored in the voice message storage device, the address book having at least one entry and a plurality of communication contact information related to at least one communication device for each entry, each of the at least one entry having an indicator for a preferred communication contact information.

18. A voice communication method, comprising:
receiving a call from a message sender at a predetermined telephone number;
receiving an audio message from the message sender;
storing the audio message in a message storage device communicatively coupled to a network;
receiving at least one identifier of at least one message receiver; and
sending a notification to at least one communication device of the at least one message receiver.

19. The method, as set forth in claim 18, wherein sending a notification to at least one communication device comprises sending a notification having a link to the stored audio message in the message storage device.

20. The method, as set forth in claim 18, further comprising receiving at least one request for the audio message from the at least one message receiver.

21. The method, as set forth in claim 18, further comprising providing the audio message to the at least one communication device of the at least one message receiver over a global network.

22. The method, as set forth in claim 18, wherein receiving a call from a message sender comprises receiving a call at a predetermined telephone number dedicated to a subscription service providing the voice communication method to its users.

23. The method, as set forth in claim 18, further comprising receiving an authenticator of DTMF signals.

24. The method, as set forth in claim 18, wherein the receiving at least one identifier of at least one message receiver comprises receiving DTMF signals.

25. The method, as set forth in claim 18, further comprising receiving an authenticator of an audio identifier.

26. The method, as set forth in claim 18, wherein the receiving at least one identifier of at least one message receiver comprises receiving an audio identifier.

27. The method, as set forth in claim 18, further comprising receiving an authenticator as an identifier spoken by the message sender.

28. The method, as set forth in claim 18, wherein the receiving at least one identifier of at least one message receiver comprises receiving an identifier spoken by the message sender.

29. The method, as set forth in claim 18, wherein the receiving at least one identifier of at least one message receiver comprises receiving an identifier and looking up the received identifier in an address book stored in the message storage device.

30. The method, as set forth in claim 18, wherein the receiving at least one identifier of at least one message receiver comprises:
receiving an identifier and looking up the received identifier in an address book stored in the message storage device;
looking up a plurality of message delivery destinations for the at least one message receiver; and
identifying a pre-selected message delivery destination from among the plurality of message delivery destinations for the at least one message receiver.

31. The method, as set forth in claim 18, further comprising receiving a message notification time from the message sender, and sending the notification at the received time.

32. The method, as set forth in claim 18, wherein sending a notification comprises preparing and sending an electronic mail notification.

33. The method, as set forth in claim 18, further comprising receiving a poll requesting status from a user interface on the communication device of the message receiver, and sending the notification to the user interface.

34. The method, as set forth in claim 18, wherein sending a notification comprises displaying an icon on a screen of the communication device of the message receiver.

35. The method, as set forth in claim 18, wherein providing the audio message comprises streaming the audio message to the communication device of the message receiver over a global network.

36. The method, as set forth in claim 18, wherein providing the audio message comprises downloading the audio message to the communication device of the message receiver over a global network.

37. The method, as set forth in claim 18, further comprising receiving an authenticator from the message sender and verifying the authenticator after receiving the call form the message sender.

38. The method, as set forth in claim 18, wherein sending a notification comprises sending a notification over the network to a communication device pursuant to a predetermined delivery time.

39. The method, as set forth in claim 18, further comprising:
receiving an authenticator for the message sender; and
verifying the authenticator.

40. The method, as set forth in claim 19 further comprising providing a hypertext link on a predetermined web page accessible to the network and to the stored audio message in the message storage device.
